(19) United States
(12) Patent Application Publication
(10) Pub. No.: US 2017/0264156 A1
(43) Pub. Date: Sep. 14, 2017

(54) STATOR OF ROTATING ELECTRIC MACHINE

(71) Applicant: HONDA MOTOR CO., LTD., Tokyo (JP)

(72) Inventors: Masaki OGAMI, Wako (JP); Keisuke AZUSAWA, Wako (JP)

(73) Assignee: HONDA MOTOR CO., LTD., Tokyo (JP)

(21) Appl. No.: 15/455,131

(22) Filed: Mar. 10, 2017

(30) Foreign Application Priority Data
Mar. 11, 2016 (JP) 2016-048338

(51) Int. Cl. H02K 3/24; H02K 9/197

(52) U.S. Cl. CPC H02K 3/24; H02K 9/197

(57) ABSTRACT

A stator of a rotating electric machine, includes a stator core, a stator coil, and a coolant guide. The stator core has a first end surface and a second end surface opposite to the first end surface in a rotational axis of the rotating electric machine. The stator core has slots that are arranged around the rotational axis and that extend along the rotational axis from the first end surface to the second end surface. The stator coil is provided in each of the slots. The stator coil has a first coil end protruding from the first end surface and a second coil end protruding from the second end surface. The coolant guide disposed between the first end surface of the stator core and the first coil end of the stator coil to guide a coolant to flow in a circumferential direction around the rotational axis.

### CROSS-REFERENCE TO RELATED APPLICATIONS

The present application claims priority under 35 U.S.C. §119 to Japanese Patent Application No. 2016-048338, filed Mar. 11, 2016, entitled “Stator of Rotating Electric Machine.” The contents of this application are incorporated herein by reference in their entirety.

### BACKGROUND

1. Field

The present disclosure relates to a stator of a rotating electric machine.

2. Description of the Related Art

To date, vehicles that use a rotating electric machine as a mechanical power source, such as electric automobiles and hybrid automobiles, have been developed. As the power of the rotating electric machine for driving a vehicle has been increasing in recent years, for example, measures for cooling of a stator coil have been examined, because the performance of a rotating electric machine decreases as the temperature of a stator coil increases.

Japanese Unexamined Patent Application Publication No. 2004-180376 describes a rotating electric machine in which a gutter is disposed above an outer periphery of a coil end and a coolant is supplied along guides to the coil end through a plurality of coolant supply holes, which are formed in a bottom surface of the gutter.

Japanese Unexamined Patent Application Publication No. 2011-155811 describes a rotating electric machine in which a coolant distribution member, having a coolant distribution channel formed therein, is disposed above a part of a coil end to which a coolant is to be supplied.

Japanese Unexamined Patent Application Publication No. 2012-222904 describes a rotating electric machine in which guide vanes are disposed on an outer peripheral surface of a cylindrical outer ring, to which a stator is fixed, and a coolant flows along the guide vanes in a circumferential direction of the cylindrical outer ring and then toward a coil end.

### SUMMARY

According to one aspect of the present invention, a stator of a rotating electric machine, includes a stator core, a stator coil, and a coolant guide. A plurality of slots are formed at predetermined intervals in the stator core in a circumferential direction. The stator coil is inserted through the slots. The coolant guide is disposed between an end surface of the stator core and at least one of coil ends of the stator coil. The at least one of coil ends protrude from the end surface of the stator core. The coolant guide guides a coolant, for cooling the stator, in the circumferential direction.

According to another aspect of the present invention, a stator of a rotating electric machine, includes a stator core, a stator coil, and a coolant guide. The stator core has a first end surface and a second end surface opposite to the first end surface in a rotational axis of the rotating electric machine. The stator core has slots that are arranged around the rotational axis and that extend along the rotational axis from the first end surface to the second end surface. The stator coil is provided in each of the slots. The stator coil has a first coil end protruding from the first end surface and a second coil end protruding from the second end surface. The coolant guide disposed between the first end surface of the stator core and the first coil end of the stator coil to guide a coolant to flow in a circumferential direction around the rotational axis.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a front view of a stator of a rotating electric machine according to an embodiment of the present disclosure.

FIG. 2 is a side view of the stator shown in FIG. 1.

FIG. 3 is an exploded perspective view of a stator core and a coolant guide shown in FIG. 1.

FIG. 4 is a partial sectional view of the stator shown in FIG. 1.

FIG. 5 is a perspective view of a coil segment.

FIGS. 6A to 6C show the cross-sectional shapes of coolant guides.

FIG. 7 is an exploded perspective view of a stator core and a coolant guide of a stator of a rotating electric machine according to a first modification.

FIG. 8 is a partial sectional view of the stator of the rotating electric machine according to the first modification.

FIG. 9 is an exploded perspective view of a stator core and a coolant guide of a stator of a rotating electric machine according to a second modification.

FIG. 10 is a partial sectional view of the stator of the rotating electric machine according to the second modification.

### DESCRIPTION OF THE EMBODIMENTS

The embodiments will now be described with reference to the accompanying drawings, wherein like reference numerals designate corresponding or identical elements throughout the various drawings.

Hereinafter, a stator of a rotating electric machine according an embodiment of the present disclosure will be described with reference to the drawings. Each of the drawings should be viewed horizontally or vertically in accordance with the orientation of the numerals.

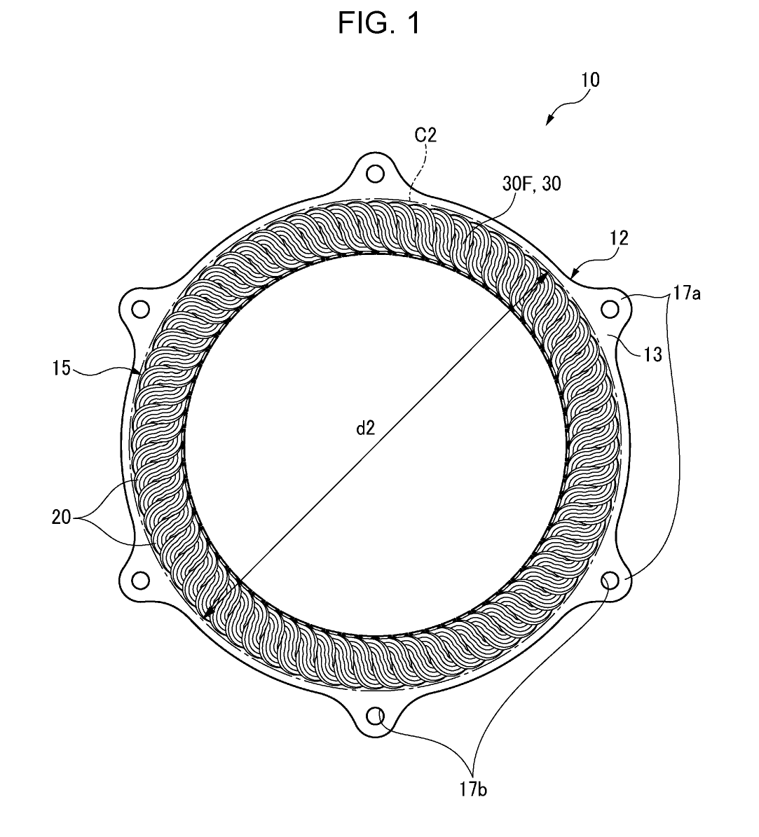

Referring to FIGS. 1 to 4, a stator 12 of a rotating electric machine 10 is contained in a housing 11. A rotor (not shown) is rotatably disposed inside the stator 12.

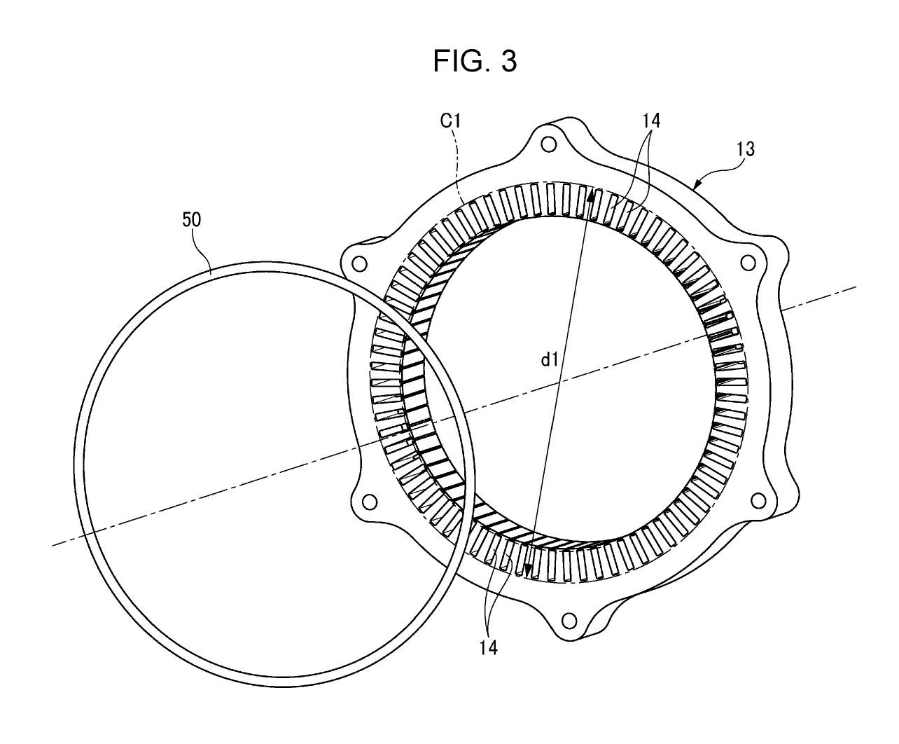

The stator 12 includes a stator core 13 and a stator coil 15. The stator core 13 has a plurality of slots 14 (see FIG. 3), which extend through the stator core 13 in the axial direction and which are arranged at predetermined intervals in the circumferential direction. The stator coil 15, for each of a plurality of phases (for example, U-phase, V-phase, and W-phase), is contained in the slots 14.

The stator core 13 is fixed to the housing 11 by inserting bolts 16 into bolt holes 17b, which are formed in a plurality of attachment portions 17a that protrude in the radial direction.

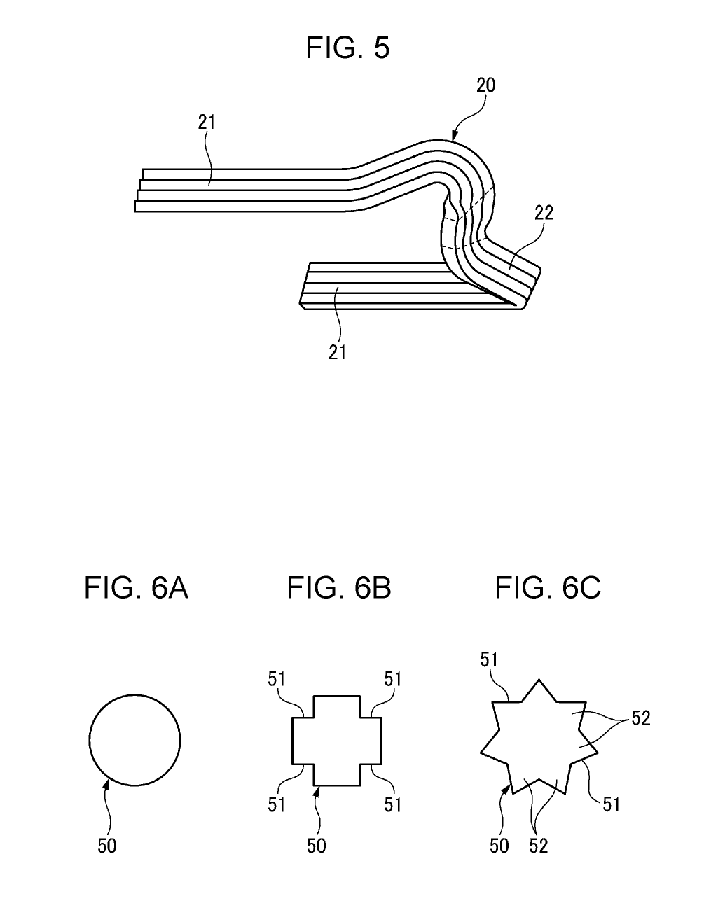

The stator coil 15 of the rotating electric machine 10 is a segment conductor coil that is formed by connecting substantially U-shaped coil segments 20 to each other. Referring to FIG. 5, each of the coil segments 20 includes a pair of legs 21 and a connection portion 22 to which one end of each of the legs 21 is connected. The stator coil 15 is formed by arranging and joining a plurality of (in the present embodiment, four) coil segments 20 together, inserting the legs 21 into the slots 14, bending protruding portions of the legs 21 protruding from the slots 14 in the circumferential direction, and joining the corresponding protruding portions to each other. Coil ends 30 protrude from both ends of the stator core 13 in the axial direction. That is, a coil end 30R is formed near a rear surface 13R of the stator core 13, from which the legs 21 protrude from the slots 14; and a coil end 30F is formed near a front surface 13F of the stator core 13, which is opposite to the rear surface 13R and on which side the connection portions 22 are disposed.

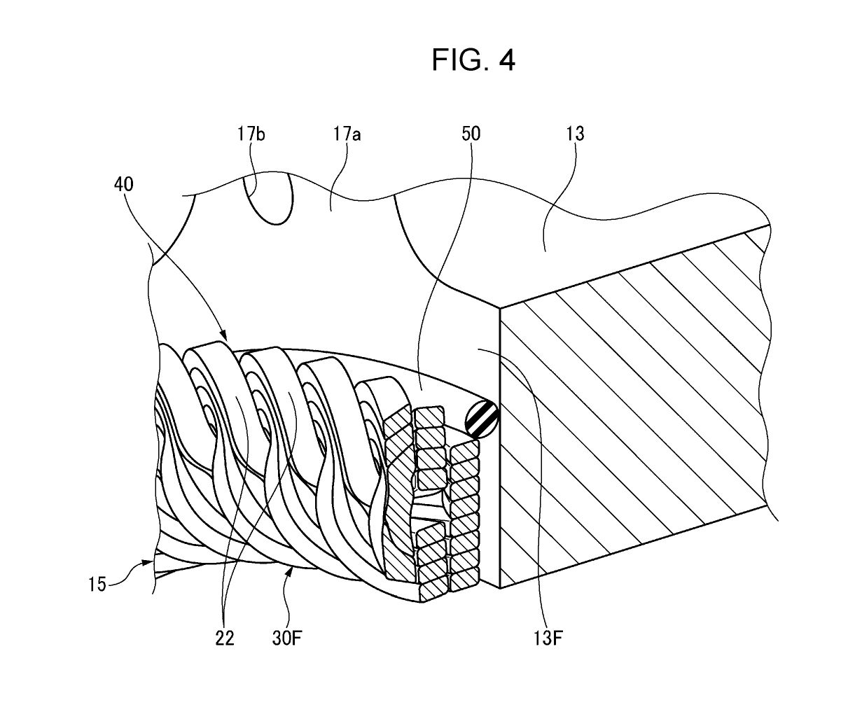

Referring to FIG. 4, at the coil end 30F of the stator coil 15, the connection portions 22 of the plurality of coil segments 20 are arranged so that the connection portions 22 are continuous in the circumferential direction and so that the connection portions 22 that are adjacent to each other in the circumferential direction overlap as seen in the axial direction. The connection portions 22 protrude from the slots 14 outward in the radial direction. For example, a groove 40, which is continuous in the circumferential direction, is formed between the front surface 13F of the stator core 13 and the coil end 30F.

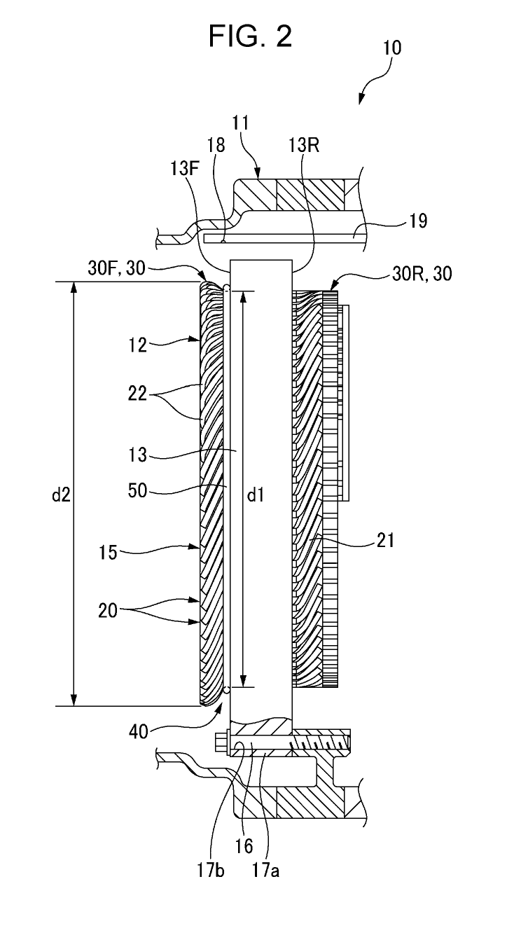

Referring to FIG. 2, at least one coolant pipe 19, for supplying a coolant to the stator coil 15, extends in the axial direction through a space above the stator core 13. A coolant discharge hole 18 is formed in the coolant pipe 19 at a position vertically above the groove 40. The coolant discharge hole 18 discharges (drips, or sprays) a coolant, such as an automatic transmission fluid (ATF) supplied from a coolant supply device (not shown), from the position above the groove 40 toward a predetermined part of the coil end 30F (for example, an uppermost part of the coil end 30F) to cool the stator coil 15.

A coolant guide 50, which has an annular shape that is continuous around the entire periphery of the stator coil 15, is disposed between the front surface 13F of the stator core 13 and the connection portions 22 of the coil end 30F. If the groove 40, which is described above as an example, is formed, the coolant guide 50 can be positioned more easily relative to the groove 40. However, the coolant guide 50 can be appropriately positioned even if the groove 40 is not formed.

The coolant guide 50 is made of a nonmagnetic material, such as resin or rubber. The coolant guide 50 has a diameter that is greater than or equal to the diameter d1 of a circle C1, which connects outer ends of the slots 14 (see FIGS. 2 and 3) in the radial direction, and smaller than or equal to the diameter d2 of a circle C2, which connects outermost ends of the connection portions 22 (see FIGS. 1 and 2) in the radial direction. The cross-sectional shape of the coolant guide 50 may be, for example, circular as shown in FIG. 6A, or may be polygonal. Examples of the polygonal shape include a shape in which small recesses 51 are formed at the four corners of a square as shown in FIG. 6B; and a shape in which small protrusions 52, each having an equilateral triangular shape, are disposed on the seven sides of a regular heptagon so that recesses 51 are formed between adjacent protrusions 52 as shown in FIG. 6C. In the examples shown in FIGS. 1 to 10, the coolant guide 50 has a circular cross section. However, when the coolant guide 50 has the protrusions 52 or the recesses 51 as shown in FIGS. 6B and 6C, the coolant guide 50 can guide the coolant more effectively. In particular, if the coolant guide 50 having the recesses 51 are disposed in the groove 40 in a twisted state, the coolant can be actively supplied to desired positons.

If the coolant guide 50 is made of an elastic material, such as rubber, even when the stator coil 15 has been attached beforehand, the coolant guide 50 can be easily attached to the groove 40 of the stator core 13 by expanding the coolant guide 50 and moving the coolant guide 50 over the stator coil 15. That is, because the coolant guide 50 can be attached after the stator coil 15 has been attached, the coolant guide 50 can be attached more easily than in a case where it is necessary to attach the stator coil 15 in a state in which the coolant guide 50 has been positioned relative to the stator core 13. Moreover, the coolant guide 50 can be fixed to the periphery of the stator coil 15 by using a contraction force of the expanded coolant guide 50.

If the coolant guide 50 is made of a non-elastic material, such as resin, the coolant guide 50 is placed beforehand on the front surface 13F of the stator core 13. Then, the stator coil 15 is attached to the stator core 13 in a state in which the coolant guide 50 has been positioned relative to the front surface 13F of the stator core 13. Thus, the coolant guide 50 is disposed in the groove 40, which is formed between the front surface 13F of the stator core 13 and the connection portions 22 of the coil end 30F.

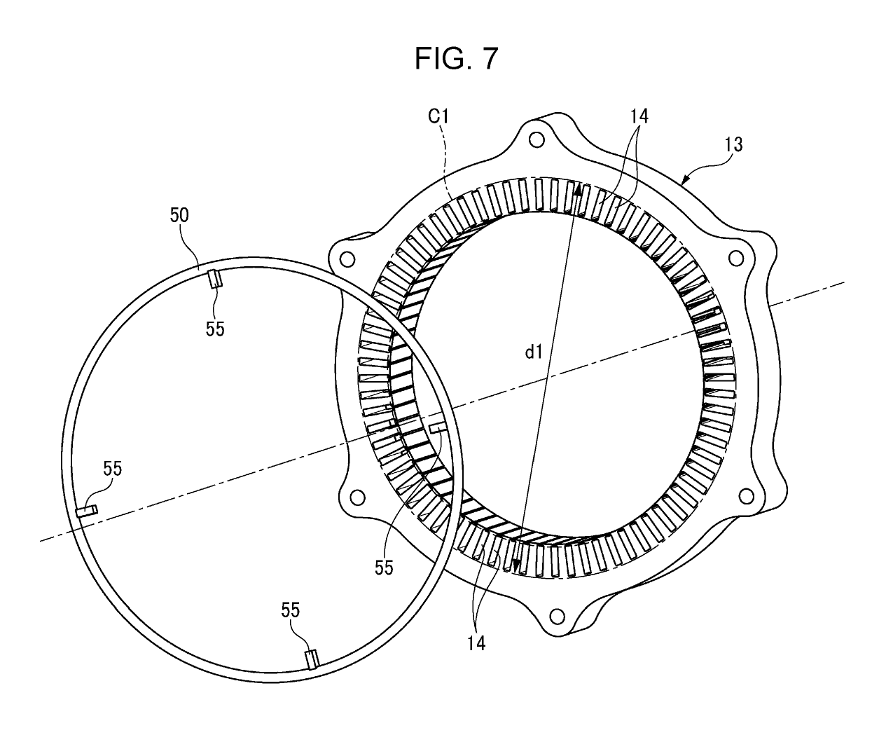

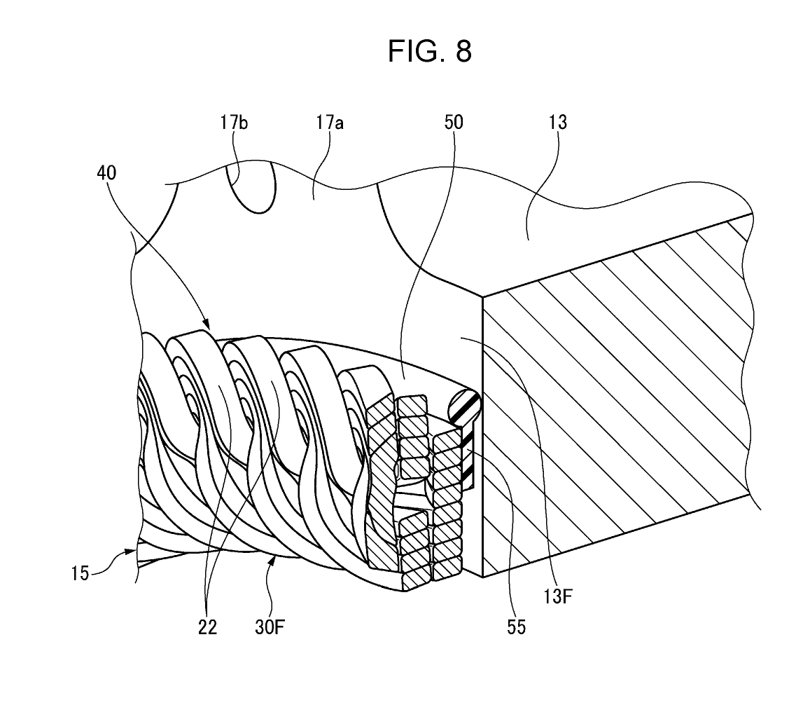

As a first modification, if the coolant guide 50 is made of a non-elastic material, it is preferable that the coolant guide 50 have at least one fixing piece 55. FIG. 7 shows an example in which the coolant guide 50 has four fixing pieces 55 that are arranged at predetermined intervals (90°) in the circumferential direction and that protrude inward in the radial direction. Referring to FIG. 8, the coolant guide 50 can be more securely fixed to the periphery of the stator coil 15 by fitting the fixing piece 55 of the coolant guide 50 into a gap between the coil end 30F and the front surface 13F of the stator core 13. Some of the fixing pieces 55 may be formed so as to protrude outward in the radial direction. In this case, by twisting and fitting the fixing pieces 55 into the gap between the coil end 30F and the front surface 13F of the stator core 13, the coolant guide 50 can be disposed in the groove 40 in a twisted state.

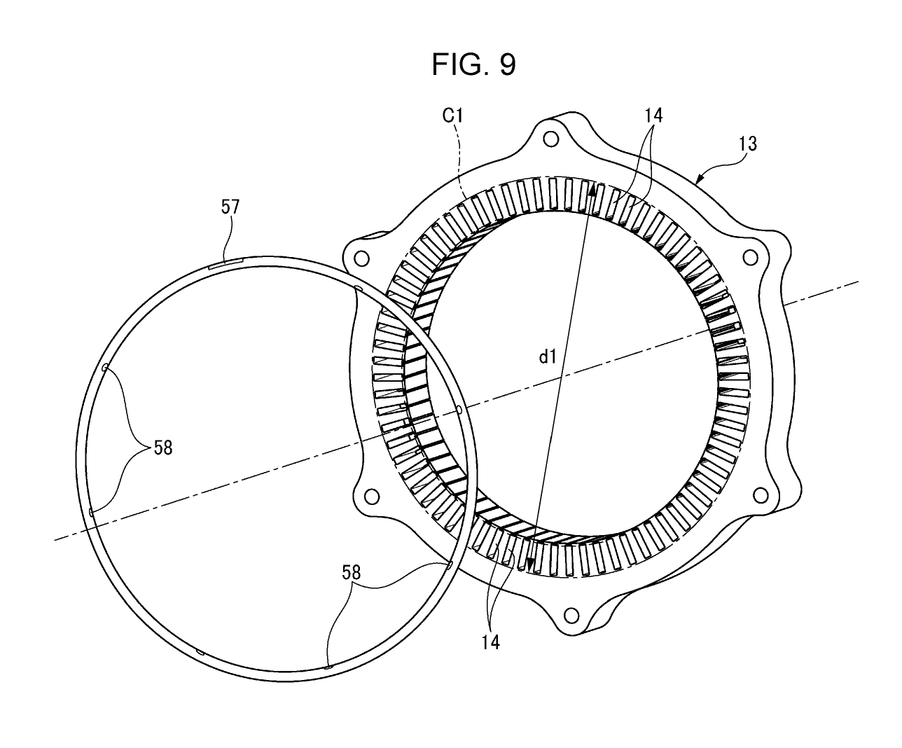

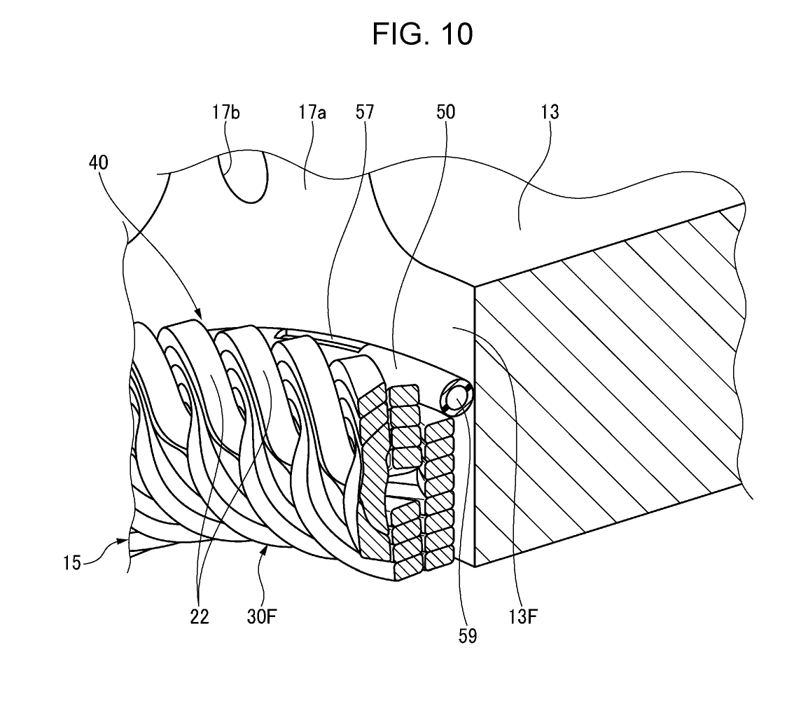

Referring to FIGS. 9 and 10, as a second modification, if the coolant guide 50 is made of a non-elastic material, the coolant guide 50 may be hollow. In this case, a coolant inlet 57 is formed in the coolant guide 50 so as to correspond to the coolant discharge hole 18 of the coolant pipe 19, and a plurality of coolant outlets 58 are formed in the coolant guide 50 so as to face the coil end 30F and so as to be arranged at predetermined intervals (in the present embodiment, at 45°) in the circumferential direction. In this case, the coolant inlet 57 and the plurality of coolant outlets 58 are connected to each other through an annular channel 59 in the hollow coolant guide 50, and therefore the coolant can be supplied to desired positions.

As described above, with the stator 12 of the rotating electric machine 10 according to the present embodiment, the coolant guide 50 is disposed between the front surface 13F of the stator core 13 and the coil end 30F, which protrudes from the front surface 13F (one end surface) of the stator core 13; and a coolant, which is supplied to the stator 12, is guided by the coolant guide 50 in the circumferential direction. Therefore, the coolant can be guided to a lower part of the stator coil 15, and increase in the temperature of the lower part of the coil can be suppressed.

The coolant guide 50 has an annular shape that is continuous around the entire periphery of the stator coil 15. Therefore, the coolant guide 50 can be fixed to the periphery of the stator coil 15 without using a special fixing portion. Moreover, the coolant can be supplied to a lower part of the stator coil 15, which is located in a lower part of the stator core 13 and to which it is not easy for the coolant to flow.

The present disclosure is not limited to the embodiment and modifications described above, which may be appropriately modified or improved. In the embodiment described above, the stator coil 15 is a segment conductor coil. However, this is not a limitation. The stator coil 15 may be a divided coil in which coils are wound in a divided manner around teeth between slots or may be a general continuously wound coil.

The shape of the coolant guide 50 need not be an annular shape and may be an arc shape a part of which is cut out. The coolant guide 50 may be disposed on each of two sides of the front surface 13F and the rear surface 13R of the stator core 13.

According to present disclosure, a stator (for example, a stator 12 in the embodiment described below) of a rotating electric machine (for example, a rotating electric machine 10 in the embodiment described below) includes a stator core (for example, a stator core 13 in the embodiment described below) in which a plurality of slots (for example, slots 14 in the embodiment described below) are formed at predetermined intervals in a circumferential direction; a stator coil (for example, a stator coil 15 in the embodiment described below) that is inserted through the slots; and a coolant guide (for example, a coolant guide 50 in the embodiment described below) guiding a coolant that is disposed between an end surface (for example, a front surface 13F in the embodiment described below) of the stator core and at least one of coil ends (for example, a coil end 30F in the embodiment described below) of the stator coil, the at least one of coil ends protruding from the end surface of the stator core, the coolant guide guiding a coolant, for cooling the stator, in the circumferential direction.

In this case, the coolant guide is disposed between the end surface of the stator core and the coil end, which protrudes from the end surface of the stator core; and the coolant, which is supplied to the stator, flows through the coolant guide in the circumferential direction. Therefore, the coolant can be guided to a lower part of the stator coil, and increase in the temperature of the lower part of the coil be suppressed.

In the stator of a rotating electric machine, the coolant guide may have an annular shape that is continuous along an entire periphery of the stator coil.

In this case, the coolant guide can be fixed to the periphery of the stator coil without using a special fixing member. Moreover, the coolant can be supplied to a lower part of the stator coil, which is located in a lower part of the stator core and to which it is not easy for the coolant to flow.

In the stator of a rotating electric machine, the coolant guide may include a fixing piece (for example, a fixing piece 55 in the embodiment described below) that protrudes in a radial direction, and the fixing piece may be fitted into a gap between the at least one of coil ends and the end surface of the stator core.

In this case, the coolant guide can be more securely fixed to the periphery of the stator coil, because the fixing piece of the coolant guide is fitted into the gap between the coil end and the end surface of the stator core.

In the stator of a rotating electric machine, the coolant guide may have a protrusion (for example, a protrusion 52 in the embodiment described below) or a recess (for example, a recess 51 in the embodiment described below) in a cross section of at least a part of the coolant guide.

In this case, the protrusion or the recess can improve the function of the coolant guide in guiding the coolant.

In the stator of a rotating electric machine, the coolant guide may be a hollow body in which a coolant inlet (for example, a coolant inlet 57 in the embodiment described below) for introducing the coolant and a coolant outlet (for example, a coolant outlet 58 in the embodiment described below) for discharging the coolant are formed.

In this case, by adjusting the position of the coolant outlet, the coolant can be supplied to a desired position without fail.

In the stator of a rotating electric machine, the coolant guide may be an elastic body that is expandable.

In this case, even when the stator coil has been attached beforehand, the coolant guide can be easily attached by expanding the coolant guide and moving the coolant guide over the stator coil. That is, the coolant guide can be attached more easily than in a case where it is necessary to attach the stator coil in a state in which the coolant guide has been positioned relative to the stator core. Moreover, the coolant guide can be fixed to the periphery of the stator coil by using a contraction force of the expanded coolant guide.

In the stator of a rotating electric machine, the coolant guide may be attached in a twisted state.

In this case, because the coolant guide is attached in a twisted state, the coolant can be actively supplied to a desired position as the coolant is guided by twists.

Obviously, numerous modifications and variations of the present invention are possible in light of the above teachings. It is therefore to be understood that within the scope of the appended claims, the invention may be practiced otherwise than as specifically described herein.

What is claimed is:

1. A stator of a rotating electric machine, comprising:
a stator core in which a plurality of slots are formed at predetermined intervals in a circumferential direction;
a stator coil that is inserted through the slots; and
a coolant guide that is disposed between an end surface of the stator core and at least one of coil ends of the stator coil, the at least one of coil ends protruding from the end surface of the stator core, the coolant guide guiding a coolant, for cooling the stator, in the circumferential direction.

2. The stator according to claim 1,
wherein the coolant guide has an annular shape that is continuous along an entire periphery of the stator coil.

3. The stator according to claim 1,
wherein the coolant guide includes a fixing piece that protrudes in a radial direction, and the fixing piece is fitted into a gap between the at least one of coil ends and the end surface of the stator core.

4. The stator according to claim 1,
wherein the coolant guide has a protrusion or a recess in a cross section of at least a part of the coolant guide.

5. The stator according to claim 1,
wherein the coolant guide is a hollow body in which a coolant inlet for introducing the coolant and a coolant outlet for discharging the coolant are formed.

6. The stator according to claim 1,
wherein the coolant guide is an elastic body that is expandable.

7. The stator according to claim 1,
wherein the coolant guide is attached in a twisted state.

8. A stator of a rotating electric machine, comprising:
a stator core having a first end surface and a second end surface opposite to the first end surface in a rotational axis of the rotating electric machine, the stator core having slots that are arranged around the rotational axis and that extend along the rotational axis from the first end surface to the second end surface;
a stator coil provided in the slots and having a first coil end protruding from the first end surface and a second coil end protruding from the second end surface; and
a coolant guide disposed between the first end surface of the stator core and the first coil end of the stator coil to guide a coolant to flow in a circumferential direction around the rotational axis.

9. The stator according to claim 8,
wherein the coolant guide has an annular shape that is continuous along an entire periphery of the stator coil.

10. The stator according to claim 8,
wherein the coolant guide includes a fixing piece that protrudes in a radial direction, and the fixing piece is fitted into a gap between at the first coil end and the first end surface of the stator core.

11. The stator according to claim 8,
wherein the coolant guide has a protrusion or a recess in a cross section of at least a part of the coolant guide.

12. The stator according to claim 8,
wherein the coolant guide is a hollow body in which a coolant inlet for introducing the coolant and a coolant outlet for discharging the coolant are formed.

13. The stator according to claim 8,
wherein the coolant guide is an elastic body that is expandable.

14. The stator according to claim 8,
wherein the coolant guide is attached in a twisted state.

15. The stator according to claim 8, further comprising:
an additional coolant guide disposed between the second end surface of the stator core and the second coil end of the stator coil to guide the coolant to flow in the circumferential direction around the rotational axis.
